(19) United States
(12) Patent Application Publication
(10) Pub. No.: US 2011/0050197 A1
(43) Pub. Date: Mar. 3, 2011

(54) Reference current or voltage generation circuit

(75) Inventor: Tachio Yuasa, Kanagawa (JP)

(73) Assignee: NEC Electronics Corporation, Kawasaki (JP)

(21) Appl. No.: 12/805,239

(22) Filed: Jul. 20, 2010

(30) Foreign Application Priority Data
Aug. 27, 2009 (JP) 2009-196175

(51) Int. Cl. G05F 3/16

(52) U.S. Cl. 323/313

(57) ABSTRACT

A reference current or voltage generation circuit which forms a self feedback circuit with a plurality of transistors and generates a reference current or a reference voltage, the reference current or voltage generation circuit including a normally-on type transistor that has a gate connected to a first power supply and is connected between a node and a second power supply. Moreover, a voltage of the node is substantially equal to a voltage of the first power supply when the reference current or voltage generation circuit does not operate, and the voltage of the node fluctuates from the voltage of the first power supply toward a voltage of the second power supply by a predetermined value or more when the reference current or voltage generation circuit operates.

INCORPORATION BY REFERENCE

This application is based upon and claims the benefit of priority from Japanese patent application No. 2009-196175, filed on Aug. 27, 2009, the disclosure of which is incorporated herein in its entirety by reference.

### BACKGROUND

1. Field of the Invention

The present invention relates to a reference current or voltage generation circuit, and more specifically, to a reference current or voltage generation circuit including a start-up circuit.

2. Description of Related Art

Voltages in the whole electronic circuit are naturally zero before power is supplied to the circuit. Now consider an electronic circuit which has elements flowing current by voltage application such as transistors, and signal paths feeding back the flowing current to the elements again. In such an electronic circuit, voltages would not be applied to the elements any longer since voltages in the whole circuit are zero just after power supply is applied. Therefore, such an electronic circuit may not operate even though enough voltage to operate circuit power supply is applied.

In this case, a leak current may occur due to noise from outside circuit or electromagnetic disturbance, by which the circuit is triggered to operate; however, such factors are caused by accident. The circuits activated due to the accidental factors are not appropriate for practical use; therefore, such a circuit includes a start-up circuit which causes artificial disturbance to the circuit.

An article written by Behzad Razavi, titled “Design of Analog CMOS Integrated Circuits”, McGraw-Hill Higher Education, pp. 380 to 381, Boston, Mass., 2002 (non-patent document) discloses a reference current or voltage generation circuit 7 including an enhancement-type MOSFET (Metal-Oxide-Semiconductor Field-Effect Transistor) as a start-up circuit. FIG. 11 shows a circuit diagram disclosed in the non-patent document. Transistors used in this circuit are enhancement-type MOSFETs. MOSFETs 11, 12, and 15 are Nch-MOSFETs, and MOSFETs 13 and 14 are Pch-MOSFETs. A resistance element 16 is connected between the MOSFET 12 and a ground.

As shown in FIG. 11, the circuit 7 further includes terminals CM1 and CM2. The reference current or voltage generation circuit 7 connects gates of the Nch-MOSFETs to the terminal CM1, to output a reference current from drains of the Nch-MOSFETs. Further, the reference current or voltage generation circuit 7 connects a resistor to a drain of the Nch-MOSFET having a gate connected to the terminal CM1, to output a voltage determined by multiplying the reference current by a resistance value of the resistor. Further, the reference current or voltage generation circuit 7 connects gates of the Pch-MOSFETs to the terminal CM2, to output the reference current from drains of the Pch-MOSFETs. Further, the reference current or voltage generation circuit 7 connects a resistor to a drain of the Pch-MOSFET having a gate connected to the terminal CM2, to output a voltage determined by multiplying the reference current by a resistance value of the resistor. In summary, the reference current or voltage generation circuit 7 outputs the current or the voltage through circuits connected to the terminals CM1 and CM2.

In the reference current or voltage generation circuit 7 shown in FIG. 11, the Nch-MOSFET 11 and the Nch-MOSFET 12 constitute a current mirror circuit whose input/output currents have nonlinear characteristics, and the Pch-MOSFET 13 and the Pch-MOSFET 14 constitute a current mirror circuit whose input/output currents have linear characteristics. The drain of the Pch-MOSFET 13 connects to the drain of the Nch-MOSFET 11, and the drain of the Pch-MOSFET 14 connects to the drain of the Nch-MOSFET 12, thereby forming a self feedback circuit. The Nch-MOSFET 15 has a source connected to the gates of the Nch-MOSFETs 11 and 12, and has a drain connected to the gates of the Pch-MOSFETs 13 and 14.

Consider a state immediately after a power supply VDD is applied to the reference current or voltage generation circuit 7. Without the Nch-MOSFET 15, all the gate-source voltages of the MOSFETs 11 to 14 are zero, which means these MOSFETs are all OFF. Hence, the current flowing in the whole circuit is stable in zero, and the circuit does not operate.

On the other hand, when the Nch-MOSFET 15 is connected, a voltage V1 is substantially set to the ground and a voltage V2 is substantially set to the power supply VDD immediately after application of the power supply VDD. Hence, a voltage difference is produced between the gate and the source of the Nch-MOSFET 15, which operates the circuit. Now, assume that threshold voltages of the MOSFETs 11, 14, and 15 are Vth11, Vth14, and Vth15, respectively. When Vth11+Vth15+Vth14<VDD, the MOSFETs 11, 14, and 15 are ON, and a drain current I3 flows through the Nch-MOSFET 15. Then, the current mirror circuit operates due to the flow of the current I3, to thereby activate the whole reference current or voltage generation circuit.

### SUMMARY

Assume that voltages between gates and sources when desired drain currents flow in the Nch-MOSFET 11 and the Pch-MOSFET 14 in the reference current or voltage generation circuit 7 shown in FIG. 11 are VGS1 and VGS4, respectively. When VGS1+Vth15+|VGS4|>VDD, the Nch-MOSFET 15 is OFF. In this condition, the start-up circuit stops the operation after the reference current or voltage generation circuit is normally activated.

However, in an enhancement-type MOSFET formed on a general semiconductor, VGS1, Vth5, and |VGS4| all have values of around 1.0 V. This means the power supply voltage VDD of the circuit should be less than about 3.0 V. However, the power supply voltage of about 3.0 V or more may be applied to circuits actually.

Therefore, the reference current or voltage generation circuit 7 shown in FIG. 11 may not satisfy the expression as above when the circuit is activated in a practical power supply voltage range. In this case, the Nch-MOSFET 15 is never turned off. Thus, even after the circuit normally activates, the Nch-MOSFET 15 which functions as the start-up circuit does not stop the operation. This disturbs the operation of the reference current or voltage generation circuit activated by the start-up circuit.

A first exemplary aspect of the present invention is a reference current or voltage generation circuit which forms a self feedback circuit with a plurality of transistors and generates a reference current or a reference voltage, the reference current or voltage generation circuit including a normally-on type transistor that has a gate connected to a first power supply and is connected between a node and a second power supply. Moreover, a voltage of the node is substantially equal to a voltage of the first power supply when the reference current or voltage generation circuit does not operate, and the voltage of the node fluctuates from the voltage of the first power supply toward a voltage of the second power supply by a predetermined value or more when the reference current or voltage generation circuit operates. Accordingly, the reference current or voltage generation circuit is activated after the power supply is applied, and the operation of the start-up circuit can be stopped after the activation of the reference current or voltage generation circuit. Therefore, the influence given on the reference current or voltage generation circuit by the start-up circuit may be reduced.

The present invention provides a reference current or voltage generation circuit which is able to reduce the influence given on the operation of the reference current or voltage generation circuit by the start-up circuit after activation of the reference current or voltage generation circuit.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a circuit diagram of a reference current or voltage generation circuit according to a first exemplary embodiment;

FIG. 2 is a circuit diagram of a reference current generation circuit using the reference current or voltage generation circuit according to the first exemplary embodiment;

FIG. 3 is a circuit diagram of a reference current generation circuit using the reference current or voltage generation circuit according to the first exemplary embodiment;

FIG. 4 is a circuit diagram of a reference voltage generation circuit using the reference current or voltage generation circuit according to the first exemplary embodiment;

FIG. 5 is a circuit diagram of a reference voltage generation circuit using the reference current or voltage generation circuit according to the first exemplary embodiment;

FIG. 6 is a circuit diagram of a reference current or voltage generation circuit according to a second exemplary embodiment;

FIG. 7 is a circuit diagram of a reference current or voltage generation circuit according to a third exemplary embodiment;

FIG. 8 is a circuit diagram of a reference current or voltage generation circuit according to a fourth exemplary embodiment;

FIG. 9 is a circuit diagram of a reference current or voltage generation circuit according to the fourth exemplary embodiment;

FIG. 10 is a circuit diagram of a bandgap reference circuit according to a fifth exemplary embodiment; and

FIG. 11 is a circuit diagram of a reference current or voltage generation circuit according to a related art.

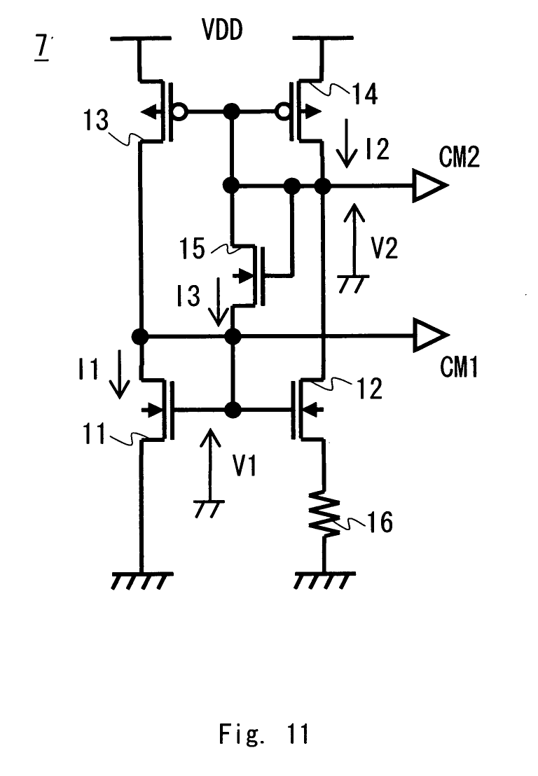

### DETAILED DESCRIPTION OF THE EXEMPLARY EMBODIMENTS

### First Exemplary Embodiment

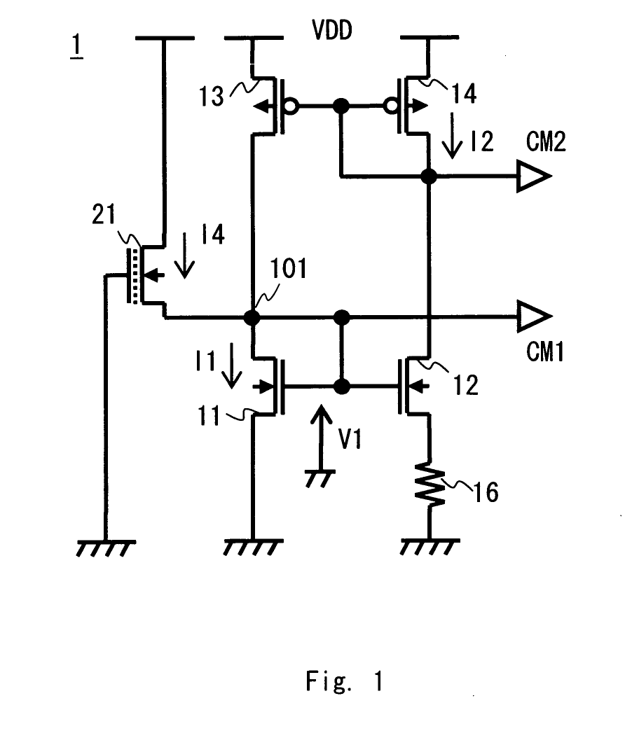

A first exemplary embodiment of the present invention will be described with reference to FIG. 1. FIG. 1 is a circuit diagram of a reference current or voltage generation circuit 1. The reference current or voltage generation circuit 1 includes enhancement-type (normally-off type) MOSFETs 11 to 14, a resistance element 16, and a normally-on type Nch-MOSFET 21. The normally-on type Nch-MOSFET 21 functions as a start-up circuit. The MOSFETs 11 and 12 are Nch-MOSFETs, and MOSFETs 13 and 14 are Pch-MOSFETs. The reference current or voltage generation circuit 1 shown in FIG. 1 further includes terminals CM1 and CM2. The reference current or voltage generation circuit 1 outputs a reference current or a reference voltage from a subsequent circuit (not shown in FIG. 1) connected to the terminals CM1 and CM2. A detailed circuit configuration to output the reference current or the reference voltage will be described later.

The Nch-MOSFET 11 has a source connected to a ground (ground voltage), and a gate connected to a drain of the Nch-MOSFET 11 and a gate of the Nch-MOSFET 12. A source of the Nch-MOSFET 12 is connected to the ground through the resistance element 16. In short, the Nch-MOSFET 11 and the Nch-MOSFET 12 constitute a Widlar current mirror circuit.

The Pch-MOSFET 14 has a source connected to a power supply VDD, and a gate connected to a drain of the Pch-MOSFET 14 and to a gate of the Pch-MOSFET 13. In short, the Pch-MOSFET 13 and the Pch-MOSFET 14 constitute a current mirror circuit having a general linear characteristic. The drain of the Nch-MOSFET 11 and a drain of the Pch-MOSFET 13 are connected, and a drain of the Nch-MOSFET 12 and the drain of the Pch-MOSFET 14 are connected.

According to the connections stated above, the reference current or voltage generation circuit 1 connects the Widlar current mirror having a nonlinear characteristic and the current mirror having a general linear characteristic, to form a self feedback circuit as a whole. By connecting inputs and outputs of a current mirror having a nonlinear characteristic with those of a current mirror having a linear characteristic, a current flowing in the whole circuit stably converges to all zero or a proper value corresponding to the input to output characteristics of both current mirrors determined by circuit constants. Note that the proper current value determined by circuit constants is determined by a characteristic ratio of the Nch-MOSFET 11 and the Nch-MOSFET 12, and a value of the resistance element 16. This current value is not substantially influenced by the power supply voltage. Further, this current value is hardly influenced by a junction temperature under circuit operation, or by property fluctuations of each element in the circuit caused of actual manufacture. Hence, the reference current or voltage generation circuit 1 operates as a circuit to generate the reference current or the reference voltage.

The normally-on type Nch-MOSFET 21 has a gate connected to the ground, a source connected to the reference current or voltage generation circuit 1, and a drain connected to the power supply VDD. A power supply connected to the gate of the normally-on type MOSFET 21 is a first power supply, and a power supply connected to the drain of the normally-on type MOSFET 21 is a second power supply. In FIG. 1, the first power supply is the ground, and the second power supply is the power supply VDD. Although the second power supply is the power supply VDD in the first exemplary embodiment, the second power supply is not limited to the power supply VDD.

As shown in FIG. 1, the source of the normally-on type Nch-MOSFET 21 is connected to a node 101 of the reference current or voltage generation circuit 1. A voltage of the node 101 is substantially equal to the ground when the reference current or voltage generation circuit 1 does not operate. When the reference current or voltage generation circuit 1 operates, the voltage of the node 101 fluctuates from the ground toward the power supply VDD by a predetermined value (threshold value of the Nch-MOSFET 11, for example) or more.

Now, an example of the operation of the reference current or voltage generation circuit 1 shown in FIG. 1 will be described. Upon application of the power supply VDD, voltages of the gates of the Nch-MOSFETs 11 and 12 in the reference current or voltage generation circuit 1 are substantially equal to the ground. Further, voltages of the gates of the Pch-MOSFETs 13 and 14 are substantially equal to the power supply VDD. In this case, the gate-source voltage of the normally-on type Nch-MOSFET 21 is zero. The normally-on type Nch-MOSFET 21 is thus turned ON to allow a current I4 to flow through the node 101.

Then, the voltages of the gates of the Nch-MOSFETs 11 and 12 increase due to the flow of the current I4. When the gate voltages of the Nch-MOSFETs 11 and 12 exceed threshold voltages of the Nch-MOSFETs 11 and 12, the current mirror composed of the Nch-MOSFETs 11 and 12 operates and a current I1 flows. The current I1 is folded back by the Nch-MOSFET 12, and the fold-back current is applied to the Pch-MOSFET 14. This fold-back current reduces the voltages of the gates of the Pch-MOSFETs 13 and 14. Then, the voltages in the Pch-MOSFETs 13 and 14 are reduced. When the gate-source voltages of the Pch-MOSFETs 13 and 14 exceed threshold voltages of the Pch-MOSFETs 13 and 14, the current mirror composed of the Pch-MOSFETs 13 and 14 operates and a current I2 flows. The reference current or voltage generation circuit 1 is activated as a whole by the above-mentioned processes.

Next, a method to stop the operation of the start-up circuit after the activation of the reference current or voltage generation circuit 1 will be described. When the reference current or voltage generation circuit 1 is in a stable operating state, a voltage V1 between the gate and the source of the Nch-MOSFET 11 reaches a threshold voltage where the drain current I1 flows. The threshold voltage between the gate and the source of the Nch-MOSFET 11 is about 1.0 V, for example. In summary, the voltage V1 is about 1.0 V when the reference current or voltage generation circuit 1 operates stably, and a voltage of the node 101 is also about 1.0 V as well. Thus, the gate-source voltage of the normally-on type Nch-MOSFET 21 is about −1.0 V.

The normally-on type Nch-MOSFET 21 is turned off when a voltage difference equal to or higher than a threshold voltage is produced between the source and the gate. As described in the example above, the threshold voltage of the normally-on type Nch-MOSFET 21 is assumed to be −1.0 V, for example. As stated above, when the reference current or voltage generation circuit 1 operates stably, the gate-source voltage of the normally-on type Nch-MOSFET 21 is about −1.0 V and the voltage reaches the voltage difference of the threshold voltage. In this state, the normally-on type Nch-MOSFET 21 is OFF and stops the operation.

In general, a voltage obtained by inverting the polarity of the threshold voltage of the normally-off type MOSFET is sufficient to turn off the normally-on type MOSFET. Therefore, desired operations are performed by setting the threshold voltage of the normally-on type Nch-MOSFET 21 to the voltage obtained by inverting the polarity of the threshold voltage of the Nch-MOSFET 11. That is, when the reference current or voltage generation circuit 1 does not operate, the current I4 causes disturbance to the reference current or voltage generation circuit 1; when the reference current or voltage generation circuit 1 starts normal operation, the current I4 is stopped to eliminate the influence given on the operation of the reference current or voltage generation circuit 1 by the start-up circuit (normally-on type Nch-MOSFET 21).

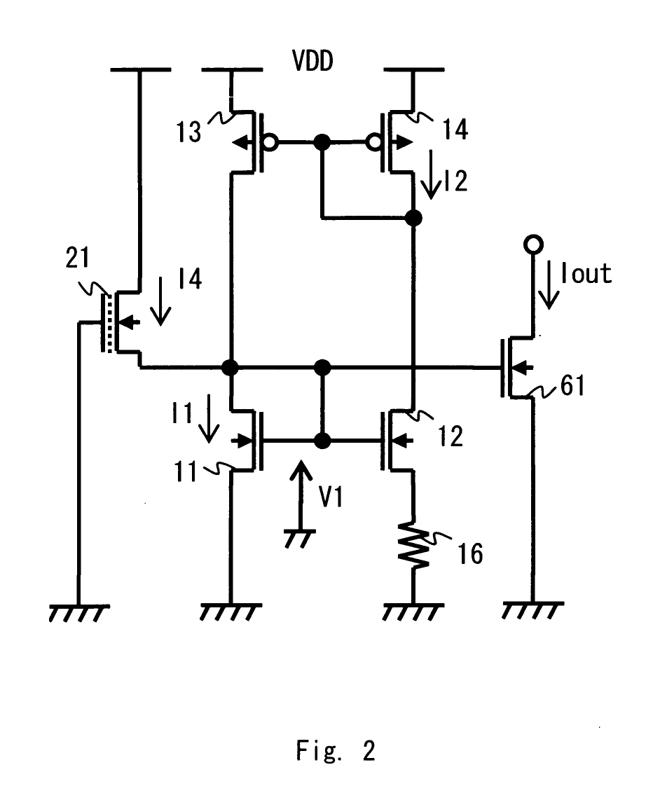

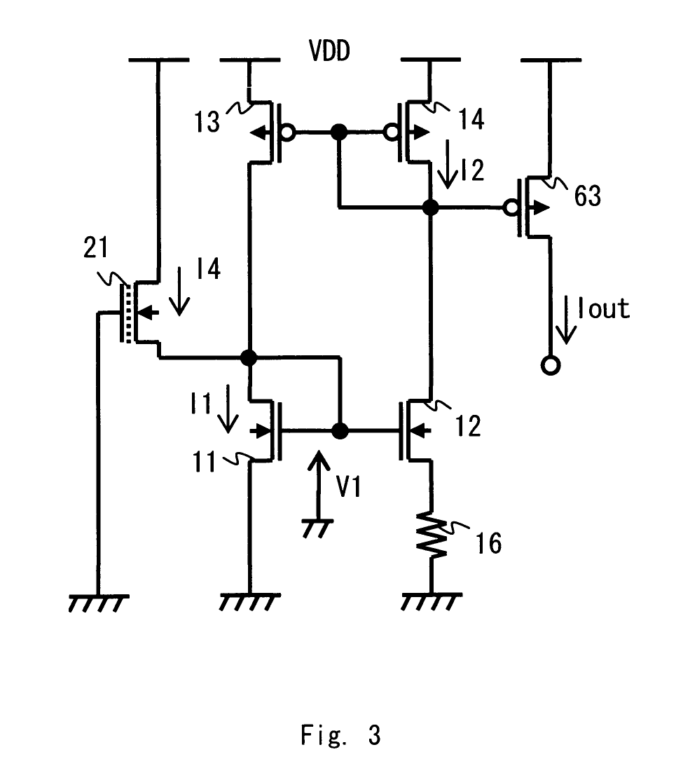

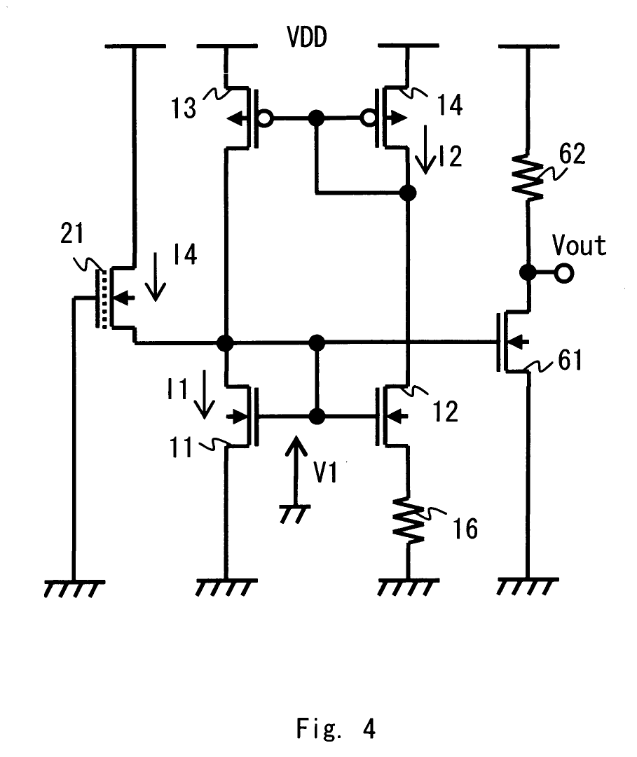

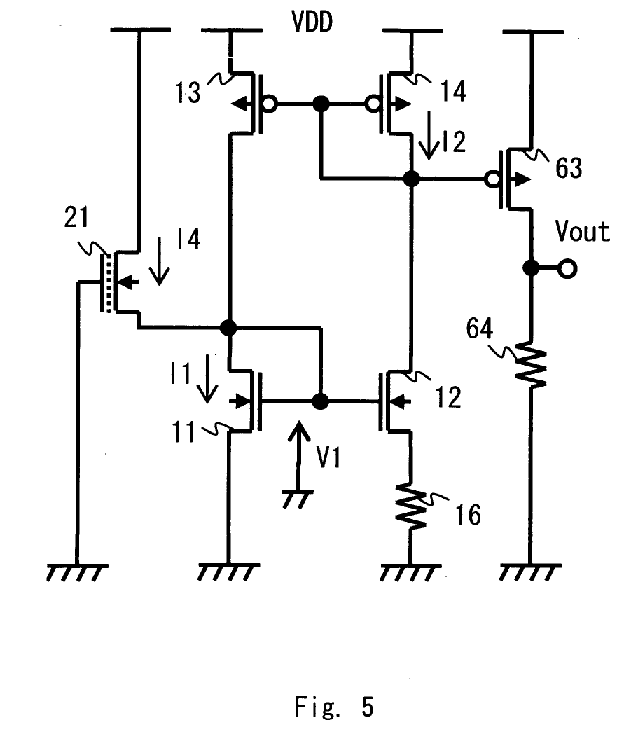

Now, description will be made of a configuration to output the reference current or the reference voltage using the reference current or voltage generation circuit 1 as shown in FIG. 1. The reference current or voltage generation circuit 1 according to the present invention does not directly output the reference current or the reference voltage from the terminals CM1 and CM2. FIGS. 2 and 3 each show a reference current generation circuit that outputs a reference current Iout, and FIGS. 4 and 5 each show a reference voltage generation circuit that outputs a reference voltage Vout, using the reference current or voltage generation circuit 1.

FIG. 2 shows an example of the reference current generation circuit that outputs the reference current from an Nch-MOSFET 61 connected to the terminal CM1. In the reference current generation circuit shown in FIG. 2, a gate of the Nch-MOSFET 61 is connected to the terminal CM1 of the reference current or voltage generation circuit 1. Further, a source of the Nch-MOSFET 61 is connected to the ground. In short, the Nch-MOSFET 11 and the Nch-MOSFET 61 constitute a current mirror circuit having a linear characteristic. A drain of the Nch-MOSFET 61 is connected to another circuit (not shown), and supplies the reference current Iout to the another circuit.

FIG. 3 shows an example of the reference current generation circuit that outputs the reference current from a Pch-MOSFET 63 connected to the terminal CM2. In the reference current generation circuit shown in FIG. 3, a gate of the Pch-MOSFET 63 is connected to the terminal CM2 of the reference current or voltage generation circuit 1. Further, a source of the Pch-MOSFET 63 is connected to the power supply VDD. In short, the Pch-MOSFET 14 and the Pch-MOSFET 63 constitute a current mirror circuit having a linear characteristic. A drain of the Pch-MOSFET 63 is connected to another circuit (not shown), and supplies the reference current Iout to the another circuit.

FIG. 4 shows an example of a circuit in which a resistance element 62 is connected between the power supply VDD and the drain of the Nch-MOSFET 61 in the reference current generation circuit shown in FIG. 2. As described above, the current Iout flows between the drain and the source of the Nch-MOSFET 61 when the reference current or voltage generation circuit 1 operates. Therefore, connecting the resistance element 62 to the current path produces a voltage between both terminals of the resistance element 62. This voltage is determined by multiplying a resistance value of the resistance element 62 by the current Iout. Then, the reference voltage Vout, which is obtained by subtracting the voltage produced between the both terminals of the resistance element 62 from a voltage of the power supply VDD, is supplied to another circuit. In summary, the circuit example shown in FIG. 4 functions as a reference voltage generation circuit that generates the reference voltage Vout having a constant difference from the voltage of the power supply VDD.

FIG. 5 shows an example of a circuit in which a resistance element 64 is connected between the ground and the drain of the Pch-MOSFET 63 in the reference current generation circuit shown in FIG. 3. As described above, the current Iout flows between the source and the drain of the Pch-MOSFET 63 when the reference current or voltage generation circuit 1 operates. Therefore, connecting the resistance element 64 to the current path produces a voltage between both terminals of the resistance element 64. This voltage is determined by multiplying a resistance value of the resistance element 64 by the current Iout. Then, the produced voltage is supplied to another circuit as the reference voltage Vout. In summary, the circuit example shown in FIG. 5 functions as a reference voltage generation circuit that generates the reference voltage Vout.

Reference current or voltage generation circuits shown in second to fourth exemplary embodiments that will be described later selectively include the Nch-MOSFET 61, the Pch-MOSFET 63, and the resistors 62 and 64 as shown in FIGS. 2 to 5, thereby outputting the reference current or the reference voltage.

As described above, the reference current or voltage generation circuit 1 according to the first exemplary embodiment uses the normally-on type Nch-MOSFET 21 as the start-up circuit. Then, the normally-on type Nch-MOSFET 21 is turned ON/OFF based on a voltage of the node 101 in the reference current or voltage generation circuit 1. At this time, the voltage of the node 101 is substantially equal to the ground when the reference current or voltage generation circuit 1 does not operate. When the reference current or voltage generation circuit 1 operates, the voltage of the node 101 fluctuates from the ground toward the power supply VDD by a threshold value of the Nch-MOSFET 11 or more. In summary, the reference current or voltage generation circuit 1 according to the first exemplary embodiment is able to switch ON/OFF operations without depending on the magnitude of the power supply voltage.

Further, the reference current or voltage generation circuit 1 according to the first exemplary embodiment stops the current I4 supplied to the reference current or voltage generation circuit 1 from the start-up circuit (normally-on type Nch-MOSFET 21) after the reference current or voltage generation circuit 1 is activated. The current I4 is stopped based on the voltage of the node 101, without depending on the magnitude of the power supply voltage. Accordingly, the reference current or voltage generation circuit 1 which is activated is able to generate the reference current or the reference voltage that less fluctuates according to the circuit constant.

### Second Exemplary Embodiment

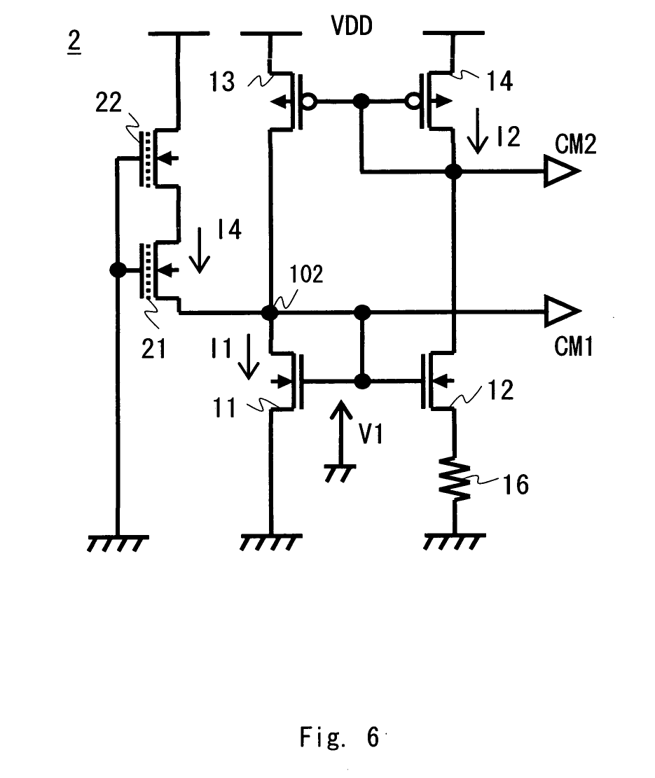

FIG. 6 shows a reference current or voltage generation circuit 2 according to a second exemplary embodiment of the present invention. The reference current or voltage generation circuit 2 shown in FIG. 6 includes two normally-on type Nch-MOSFETs that operate as a start-up circuit. The structures of the MOSFETs 11 to 14 are similar to those in the reference current or voltage generation circuit 1 shown in FIG. 1, and description thereof will be omitted.

The normally-on type Nch-MOSFETs 21 and 22 are connected in series with a node 102 (corresponding to the node 101 shown in FIG. 1). Both gates of the normally-on type Nch-MOSFETs are connected to the ground. Generally, a drain current of a MOSFET is proportional to a ratio W/L of a gate width W to a gate length L.

The W/L ratio when the normally-on type Nch-MOSFETs 21 and 22 are the same will be described with reference to FIG. 6. The normally-on type Nch-MOSFETs 21 and 22 are connected in series, and the gate width W of the normally-on type Nch-MOSFET shown in FIG. 6 is equal to that in the reference current or voltage generation circuit 1 shown in FIG. 1. As the normally-on type Nch-MOSFETs 21 and 22 are connected in series in the reference current or voltage generation circuit 2, the gate length L is twice as large as that in the reference current or voltage generation circuit 1 that only includes the normally-on type Nch-MOSFET 21.

Hence, the current I4 that flows through the two MOSFETs is half as large as that in the reference current or voltage generation circuit 1 shown in FIG. 1. Further, a leak current when the start-up circuit is OFF is also halved. Although not shown in FIG. 6, when the two normally-on type Nch-MOSFETs are connected in parallel, the gate length L is unchanged and the gate width W is doubled. Thus, the drain current and the leak current that flow from the start-up circuit are twice as large as those in the start-up circuit including only one normally-on type Nch-MOSFET. Although the normally-on type Nch-MOSFETs 21 and 22 are described as the same for the sake of clarity, they may be different from each other. Further, the number of normally-on type MOSFETs used for the start-up circuit is not limited to two, but may be three or more.

In general, larger current flowing with the start-up circuit being ON ensures activation of the target circuit. However, the leak current also increases. In a practical circuit design, the circuit constant needs to be determined to satisfy the conflicting characteristics based on the circuit characteristics including the threshold values of the MOSFETs used for a circuit activated by the start-up circuit.

The reference current or voltage generation circuit 2 according to the second exemplary embodiment clarifies a relation between the circuit characteristics and the circuit constant discussed above, which facilitates determination of the circuit constant.

### Third Exemplary Embodiment

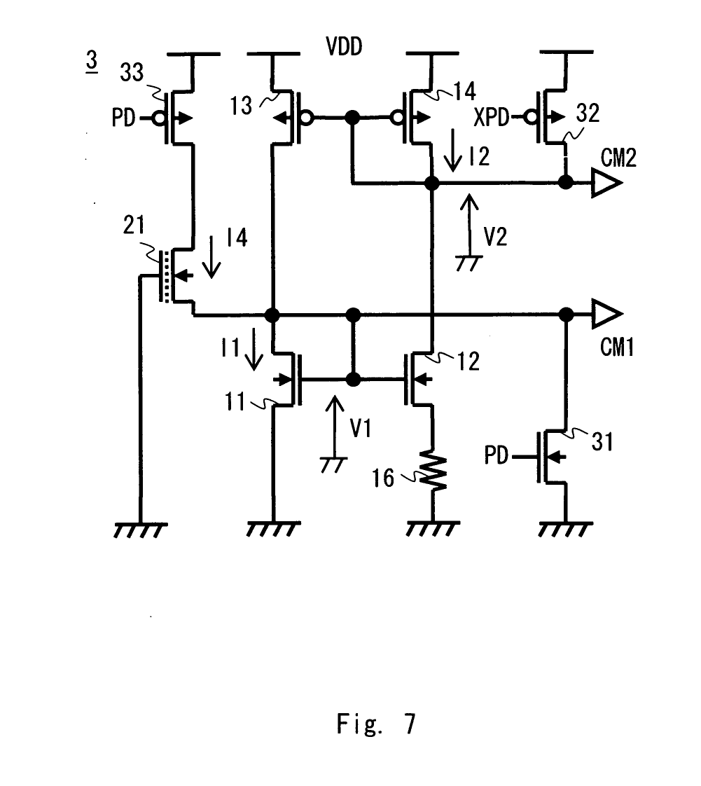

A reference current or voltage generation circuit 3 according to a third exemplary embodiment of the present invention will be described. FIG. 7 shows a circuit example of the reference current or voltage generation circuit 3. The reference current or voltage generation circuit 3 further includes an enhancement-type Nch-MOSFET 31 and enhancement-type Pch-MOSFETs 32 and 33 in addition to the components of the reference current or voltage generation circuit 1 shown in FIG. 1. The Pch-MOSFET 33 functions as a first switch and the Nch-MOSFET 31 functions as a second switch.

The Nch-MOSFET 31 is connected between the terminal CM1 and the ground, and the Pch-MOSFET 32 is connected between the terminal CM2 and the power supply VDD. The Pch-MOSFET 33 is connected between the drain of the normally-on type Nch-MOSFET 21 and the power supply VDD.

Further, the Nch-MOSFET 31 and the Pch-MOSFET 33 receive a signal PD (Power Down) from other circuits (not shown). The Nch-MOSFET 31 is ON when the signal PD is H (High), and is OFF when the signal PD is L (Low). Further, the Pch-MOSFET 33 is OFF when the signal PD is H, and is ON when the signal PD is L. The Pch-MOSFET 32 receives a signal XPD having an inverted logical value of the signal PD. The Pch-MOSFET 32 is OFF when the signal XPD is H, and is ON when the signal XPD is L.

Subsequently, an example of the operation of the reference current or voltage generation circuit 3 shown in FIG. 7 will be described. In a normal operating state, the Nch-MOSFET 31 and the Pch-MOSFET 32 are OFF, and the Pch-MOSFET 33 is ON. In short, the reference current or voltage generation circuit 3 shown in FIG. 7 is equivalent to the reference current or voltage generation circuit 1 according to the first exemplary embodiment. The circuit operation is similar to that in the reference current or voltage generation circuit 1 shown in FIG. 1, and thus description thereof will be omitted.

The reference current or voltage generation circuit 3 has a power down function. The power down function is the function to set the power supply current consumed in the circuit when the circuit operation is not required to substantially zero. When the circuit is set in a power down state by the power down function, the signal PD is H and the signal XPD is L. With such logical levels of the signal PD and the signal XPD, the Nch-MOSFET 31 and the Pch-MOSFET 32 are ON and the Pch-MOSFET 33 is OFF. Hence, in the reference current or voltage generation circuit 3, the gate-source voltages of the MOSFETs 11 to 14 are forcibly set to zero, to thereby stop the operation of the reference current or voltage generation circuit 3. Further, the Pch-MOSFET 33 is OFF, thereby interrupting the current flowing from the power supply VDD to the ground through the Pch-MOSFET 33, the normally-on type Nch-MOSFET 21, and the Nch-MOSFET 31. Although the MOSFETs are used as the switch circuits in FIG. 7, other devices may be used as long as they can turn ON/OFF the connections.

The reference current or voltage generation circuit 3 has the power down function, thereby making it possible to stop the operation of the circuit without turning on or off the power supply VDD. In short, the reference current or voltage generation circuit 3 has the power down function, thereby finely saving and controlling the current consumption in the whole electronic device.

Recently, developing environmentally-friendly electronic devices have been socially demanded. Such a demand may be satisfied with the power down function. Further, in the reference current or voltage generation circuit 3 which is set in the power down state by the power down function, the terminal CM1 is connected to the ground, and the terminal CM2 is connected to the VDD. In summary, the gate-source voltages of the Nch-MOSFET connected to the terminal CM1 (e.g. Nch-MOSFET 61 shown in FIG. 2) and of the Pch-MOSFET connected to the terminal CM2 (e.g. Pch-MOSFET 63 shown in FIG. 3) are zero, and these MOSFETs which are provided at the output stage of current mirror are OFF as well. Accordingly, the reference current or voltage generation circuit 3 which is in the power down state can stably set the power supply current consumed in the circuit that receives the reference current or the reference voltage to zero.

### Fourth Exemplary Embodiment

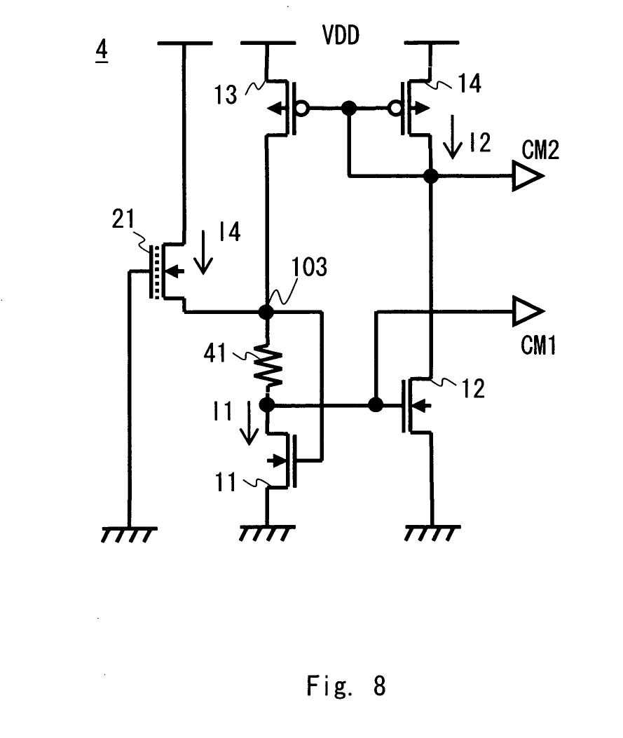

FIG. 8 shows an example of a reference current or voltage generation circuit 4 according to a fourth exemplary embodiment. In the reference current or voltage generation circuit 4, the Widlar current mirror circuit in the reference current or voltage generation circuit 1 shown in FIG. 1 is replaced with a Peaking current mirror circuit. The reference current or voltage generation circuit 4 shown in FIG. 8 constitutes the Peaking current mirror circuit with the Nch-MOSFETs 11 and 12 and a resistance element 41.

In FIG. 8, the resistance element 41 has one terminal connected to the drain of the Nch-MOSFET 11 and the gate of the Nch-MOSFET 12, and the other terminal connected to the drain of the Pch-MOSFET 13. Further, the reference current or voltage generation circuit 4 shown in FIG. 8 is different from the reference current or voltage generation circuit 1 shown in FIG. 1 in that the drain of the Nch-MOSFET 11 and the gate of the Nch-MOSFET 12 are connected, and the source of the normally-on type Nch-MOSFET 21 is connected to a node 103 between the gate of the Nch-MOSFET 11 and the resistance element 41.

While the Nch-MOSFETs 11 and 12 and the resistance element 16 constitute a Widlar current mirror in the reference current or voltage generation circuit 1 shown in FIG. 1, the Nch-MOSFETs 11 and 12 and the resistance element 41 constitute a Peaking current mirror in the reference current or voltage generation circuit 4. The Widlar current mirror and the Peaking current mirror have different characteristics; however, both have a nonlinear characteristic regarding a relation between the current I1 and the current I2.

By forming a self feedback circuit by connecting the Peaking current mirror with the current mirror having a linear characteristic, a current flowing in the whole circuit has a specific value determined by the circuit constant. Thus, the whole circuit functions as a reference current or voltage generation circuit. The circuit operations are similar to those in the first exemplary embodiment. The current I4 increases the gate voltage of the Nch-MOSFET 11 and the current I1 flows. At the same time, the gate voltage of the Nch-MOSFET 12 increases as well, which turns on the Nch-MOSFET 12. The current I2 flows through the Pch-MOSFET 14, which turns on the Pch-MOSFET 13. Thus, the whole circuit activates. The specific operations in the start-up circuit are similar to those in the reference current or voltage generation circuit 1 shown in FIG. 1, and thus description will be omitted.

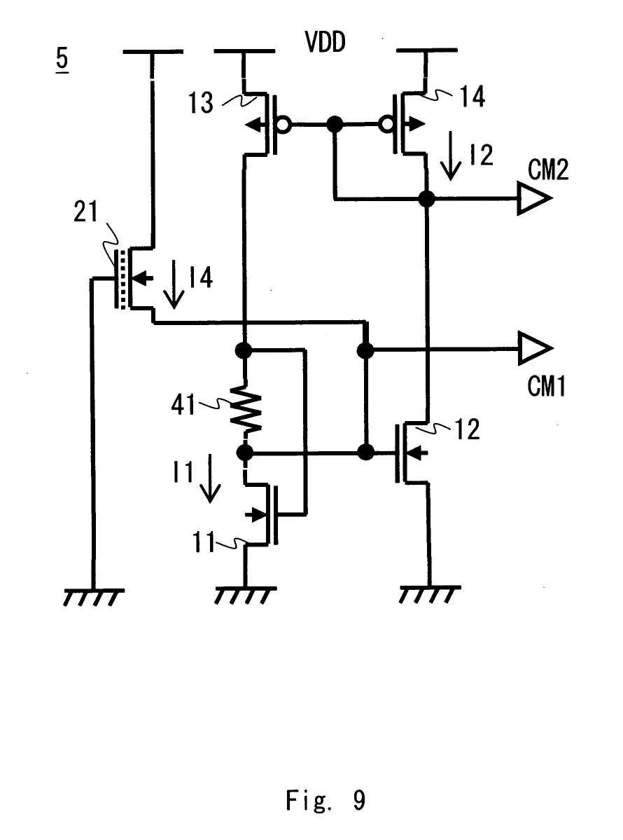

FIG. 9 shows a modified example of the reference current or voltage generation circuit 4 shown in FIG. 8. The reference current or voltage generation circuit 4 shown in FIG. 8 activates with the Nch-MOSFET 11 turned on when the voltage difference is produced between the gate and the source of the Nch-MOSFET 11. In the modified example shown in FIG. 9, the source of the normally-on type Nch-MOSFET 21 is connected to the gate of the Nch-MOSFET 12. The advantageous effect of the present invention can be attained with such a configuration as well. Specifically, the gate voltage of the Nch-MOSFET 12 increases due to the flow of the current I4 immediately after the power supply VDD is applied, and thus the Nch-MOSFET 12 is ON. When a reference current or voltage generation circuit 5 operates, the gate voltage of the Nch-MOSFET 12 increases up to the threshold voltage. Thus, the voltage difference is produced between the gate and the source of the normally-on type Nch-MOSFET 21, and the normally-on type Nch-MOSFET 21 stops the operation.

The reference current or voltage generation circuit 4 according to the fourth exemplary embodiment is able to generate the reference current or the reference voltage also by using the Peaking current mirror having a nonlinear characteristic.

### Fifth Exemplary Embodiment

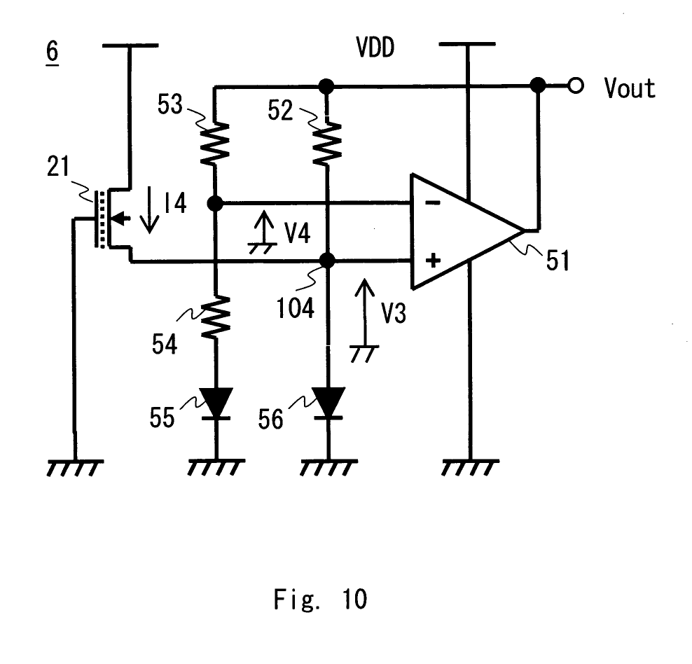

In a fifth exemplary embodiment, a typical bandgap reference circuit will be described as one example of the reference current or voltage generation circuit. The bandgap reference circuit generates a reference voltage without using a reference current. In the fifth exemplary embodiment, the bandgap reference circuit is used to indicate the circuit according to the present invention. A bandgap reference circuit 6 will be described with reference to FIG. 10. The bandgap reference circuit 6 forms a typical bandgap reference circuit. The bandgap reference circuit 6 stably outputs a voltage of about 1.2 V from Vout without being influenced by the power supply voltage, the junction temperature, and property fluctuations caused when various types of elements constituting the circuit are actually manufactured. The bandgap reference circuit 6 outputs the reference voltage Vout without using the Nch-MOSFET 61, the Pch-MOSFET 63, and the resistors 62 and 64 shown in FIGS. 2 to 5. The bandgap reference circuit 6 includes an operational amplifier 51, resistance elements 52, 53, and 54, and PN junction diodes 55 and 56.

An output node of the operational amplifier 51 is connected to a plus (non-inverting) input of the operational amplifier 51 through the resistance element 52. The output node of the operational amplifier 51 is further connected to a minus (inverting) input of the operational amplifier 51 through the resistance element 53. Further, the resistance element 54 and the PN junction diode 55 are connected in series with the resistance element 53, and the PN junction diodes 56 is connected in series with the resistance element 52. The source of the normally-on type Nch-MOSFET 21 in the start-up circuit is connected to a node 104 of the self feedback circuit. The node 104 is connected to the plus input of the operational amplifier 51.

The bandgap reference circuit 6 as a whole forms a self feedback circuit, which means the circuit may not activate even after application of power. In order to solve this problem, the bandgap reference circuit 6 needs to include a start-up circuit.

First, the operation when the bandgap reference circuit 6 does not include the normally-on type Nch-MOSFET 21 will be specifically described. Immediately after the power supply to the bandgap reference circuit 6 is turned on, all the nodes that constitute the bandgap reference circuit 6 have the same voltage of zero. Specifically, a voltage V3 of the plus input and a voltage V4 of the minus input of the operational amplifier 51, and the output voltage Vout are all zero. Accordingly, even after the power supply is applied and the power supply voltage reaches a voltage that is sufficient to operate the bandgap reference circuit 6, Vout does not necessarily exceed about 0.6 V to 0.7 V, which is a forward voltage in a period in which the PN junction diodes 55 and 56 are ON. In the bandgap reference circuit 6, the PN junction diodes 55 and 56 are conducted only when the operational amplifier 51 generates the reference voltage Vout that exceeds about 0.6 V to 0.7 V. Therefore, the bandgap reference circuit 6 does not operate permanently.

Next, the operation when the bandgap reference circuit 6 includes the normally-on type Nch-MOSFET 21 will be described. Immediately after the power supply to the bandgap reference circuit 6 is turned on, the gate-source voltage of the normally-on type Nch-MOSFET 21 is zero if the voltage V3 of the plus input of the operational amplifier 51 is zero. Since the normally-on type Nch-MOSFET 21 is a depletion-type MOSFET, the Nch-MOSFET 21 is ON when the gate-source voltage is zero, and the current I4 tends to flow. The flow of the current I4 increases the voltage V3 of the plus input of the operational amplifier 51 to a voltage that exceeds at least about 0.6 V to 0.7 V. On the other hand, the voltage V4 of the minus input of the operational amplifier 51 remains zero. Thus, the operational amplifier 51 amplifies the differential voltage, and Vout increases substantially up to VDD. Then, the voltage V3 of the plus input and the voltage V4 of the minus input increase up to a forward voltage in a period in which the PN junction diodes 55 and 56 are ON through the resistance elements 52 to 54, and the current flows. By the above-mentioned processes, the whole bandgap reference circuit 6 activates.

When the whole bandgap reference circuit 6 stably operates, the voltage V3 of the plus input reaches a voltage that exceeds about 0.6 V to 0.7 V, which is a forward voltage in a period in which the PN junction diode 56 is ON. The voltage V3 of the plus input is applied as the gate-source voltage whose polarity is inverted with respect to the normally-on type Nch-MOSFET 21. When the threshold voltage of the normally-on type Nch-MOSFET 21 is about −0.6 V to −0.7 V, the normally-on type Nch-MOSFET 21 whose gate-source voltage reaches the forward voltage of the PN junction diode 56 is OFF.

As stated above, the bandgap reference circuit 6 according to the fifth exemplary embodiment supplies the current I4 to the plus input of the operational amplifier 51 by the normally-on type Nch-MOSFET 21 to increase the voltage of the node until activation of the bandgap reference circuit 6. Hence, the bandgap reference circuit 6 reliably activates. On the other hand, after activation of the bandgap reference circuit 6, the normally-on type Nch-MOSFET 21 is OFF by the application of the voltage V3 of the plus input. This operation is not substantially influenced by the power supply voltage. This solves the problem that the start-up circuit may not stop even after the target circuit normally activates.

The first to fifth exemplary embodiments can be combined as desirable by one of ordinary skill in the art. For example, a current mirror circuit having a nonlinear characteristic may be composed of Pch-MOSFETs and a current mirror circuit having a linear characteristic may be composed of Nch-MOSFETs. Further, polarities of the normally-on type MOSFET may be changed, and the connection forms may be changed as appropriate according to the change of the polarities.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A reference current or voltage generation circuit which forms a self feedback circuit with a plurality of transistors and generates a reference current or a reference voltage, the reference current or voltage generation circuit comprising:
a normally-on type transistor that has a gate connected to a first power supply and is connected between a node and a second power supply, wherein
a voltage of the node is substantially equal to a voltage of the first power supply when the reference current or voltage generation circuit does not operate, and
the voltage of the node fluctuates from the voltage of the first power supply toward a voltage of the second power supply by a predetermined value or more when the reference current or voltage generation circuit operates.

2. The reference current or voltage generation circuit according to claim 1, wherein the normally-on type transistor is turned off when a voltage difference between a source and the gate of the normally-on type transistor is equal to or more than the predetermined value.

3. The reference current or voltage generation circuit according to claim 1, further comprising:
a first switch which is provided between the node and the first power supply; and
a second switch which is provided between the normally-on type transistor and the second power supply,
wherein the first switch and the second switch are exclusively in a conduction state.

4. The reference current or voltage generation circuit according to claim 1, further comprising:
a first current mirror circuit that includes a first transistor provided in a first current path and a second transistor provided in a second current path, gates of the first and second transistors being connected each other;
a second current mirror circuit that includes a third transistor provided in the first current path and a fourth transistor provided in the second current path, gates of the third and fourth transistors being connected each other; and
a resistance element which is provided between the second transistor and one of the first power supply and the second power supply,
wherein a source of the normally-on type transistor is connected to a node to which a drain and a gate of the first transistor are connected.

5. The reference current or voltage generation circuit according to claim 1, further comprising:
a first current mirror circuit that includes a first transistor provided in a first current path and a second transistor provided in a second current path, gates of the first and second transistors being connected each other;
a second current mirror circuit that includes a third transistor provided in the first current path and a fourth transistor provided in the second current path, gates of the third and fourth transistors being connected each other; and
a resistance element which is provided in the first current path, the resistance element having one terminal connected to a node to which a drain of the first transistor and the gate of the second transistor are connected and another terminal connected to a node to which the first current path and the gate of the first transistor are connected,
wherein a source of the normally-on type transistor is connected to the node to which the first current path and the gate of the first transistor are connected.

6. The reference current or voltage generation circuit according to claim 1, further comprising:
a first current mirror circuit that includes a first transistor provided in a first current path and a second transistor provided in a second current path, gates of the first and second transistors being connected each other;
a second current mirror circuit that includes a third transistor provided in the first current path and a fourth transistor provided in the second current path, gates of the third and fourth transistors being connected each other; and
a resistance element which is provided in the first current path, the resistance element having one terminal connected to a node to which a drain of the first transistor and the gate of the second transistor are connected and another terminal connected to a node to which the first current path and the gate of the first transistor are connected,
wherein a source of the normally-on type transistor is connected to the gate of the second transistor.

7. The reference current or voltage generation circuit according to claim 1, further comprising:
an operational amplifier;
a first resistance element which is provided between an output of the operational amplifier and an inverting terminal of the operational amplifier;
a second resistance element which is provided between the output of the operational amplifier and a non-inverting terminal of the operational amplifier;
a first diode which is provided between the first resistance element and the first power supply, the first diode being provided in a forward direction with respect to the first power supply;
a third resistance element which is provided between the first resistance element and the first diode; and
a second diode which is provided between the second resistance element and the first power supply, the second diode being provided in a forward direction with respect to the first power supply,
wherein a source of the normally-on type transistor is connected between the second resistance element and the non-inverting terminal.
